(19) United States
(12) Patent Application Publication
(10) Pub. No.: US 2007/0136333 A1
(43) Pub. Date: Jun. 14, 2007

(54) METHOD OF INSPECTION AND A USER INTERFACE FOR A BUSINESS MEASURE MODELING TOOL

(76) Inventor: KHALED GAMAL HASSAN ABD ELRAHMAN, (US)

Correspondence Address: IBM CORPORATION;INTELLECTUAL PROPERTY LAW, 11400 BURNET ROAD, AUSTIN, TX, 78758, US

(21) Appl. No.: 11/567,759

(22) Filed: Dec. 7, 2006

(30) Foreign Application Priority Data
Dec. 14, 2005 (EP) 05112105.1

(51) Int. Cl. G06F 7/00

(52) U.S. Cl. 707/100

(57) ABSTRACT

A method of carrying out a certain action on a model, such as a business measures model (BOM Observation Model), wherein the model includes a plurality of elements, the or each of which represent a part of the model, the method comprising extracting each element of the model using a element extraction process; determining a logical grouping for each extracted element; determining one or more parameters relating to each extracted element; determining a hierarchy of the extracted elements to produce a hierarchical tree diagram of the extracted elements of the model based on the logical grouping; including the or each parameter with each extracted element in the hierarchical tree diagram; and using the hierarchical tree diagram to access the one or more parameters of each element to allow the certain action to be carried out.

### TECHNICAL FIELD OF THE INVENTION

This invention relates to a method of interfacing a user interface for a modeling tool, particularly a method and interface which enables user visualization of a business measures modeling (BOM Observation Model).

### BACKGROUND ART

There are many business modeling tools which exist and offer users the ability to optimize some or all of the business operations of a particular company.

IBM WebSphere Business Modeler (“IBMWebsphere” is a trademark of IBM Corporation)is one such business modeling tool. The IBM WebSphereBusiness Modeler (“IBM Websphere” is a trademark of IBM Corporation) provides a tool which carries out business modeling, simulation, analysis and collaboration capabilities. In the area of business modeling this includes features such as process modeling, enterprise modeling, data and artifact modeling, organization modeling, resource modeling and timeline and location modeling.

The advantages of these types of models is that the business model can be used to understand how many aspects of the business are modeled before they are deployed. Also the modeling tools help to reduce costs and increase business productivity.

Having established a business model for a particular organization there is sometimes a need to monitor the business processes that have been implemented, so as to continuously make improvements to them. The WebSphere Business Monitor enables just such a monitoring process. The modeling process is implemented on an Eclipse platform using the Eclipse Modeling Framework (EMF). EMF is an open source framework for developing model driven applications. It creates a Java Ô code for manipulating reading and serializing data based on the model.

For some users the model and the Eclipse modeling framework are too complex to understand, as a reasonable level of computer and computer language knowledge is required. Accordingly there is often a requirement to transform user information into the model and vice versa.

An object of the present invention is to provide a method and system by which a user can have a clear view of a business measures model (BOM Observation Model) implemented on a modeling system. A further object is to enable inspection debugging, amending and editing of the model in a manner which does not require a high level of knowledge of the relevant computer languages.

### SUMMARY OF THE INVENTION

The present invention is directed to the method and system as defined in the independent claims.

More particularly the present invention discloses a method of carrying out a certain action on a model, such as a business model, wherein the model includes a plurality of elements, the or each of which represent a part of the model, the method comprising:
extracting each element of the model using a element extraction process;
determining a logical grouping for each extracted element;
determining one or more parameters relating to each extracted element;
determining a hierarchy of the extracted elements to produce a hierarchical tree diagram of the extracted elements of the model based on the logical grouping;
including the or each parameter with each extracted element in the hierarchical tree diagram;
using the hierarchical tree diagram to access the one or more parameters of each element to allow the certain action to be carried out.

Further embodiments of the invention are provided in the appended dependent claims.

The advantages of the present invention are that the inventions provides a method and a system by which a user can view and edit a business model at high level without the need for learning and understanding complex computer systems, programs or languages.

### BRIEF DESCRIPTION OF THE DRAWINGS

FIG. 1 is an overview of a business modeling system according to the present invention.

FIG. 2 is a tree diagram of a monitoring context for an observation model.

FIG. 3 is a property view of the properties of selected elements of the tree of FIG. 2.

FIG. 4 is a block diagram for illustrating how logical grouping nodes are linked with classes for the Eclipse (EMF) property view.

FIG. 5 is a screen shot of the property view of FIG. 3 with an attributes values operation box.

FIG. 6 is a screen shot of an observation monitor which has rebuilt the model for illustration to the user.

FIG. 7 is a block diagram showing a first part of the method steps of the present invention.

FIG. 8 is a block diagram showing a second part of the method steps of the present invention.

### DETAILED DESCRIPTION OF THE PREFERRED EMBODIMENT

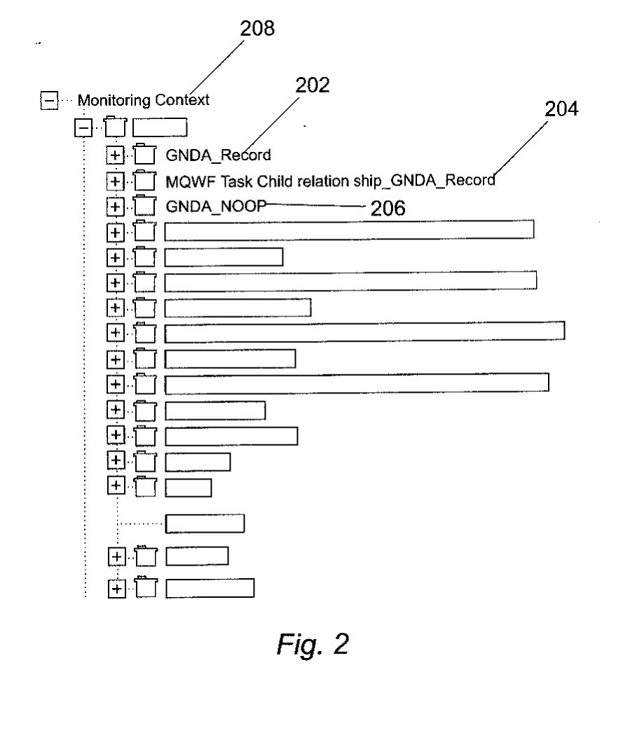

In FIGS. 2, 3, 5 and 6 not all of the drawing elements are shown in detail. Instead they are represented by a selection of different boxes. The boxes represent element names, properties and values as will be clear from the drawings. Any hatched boxes represent a selected item. The details represented by the boxes will be variable in practice depending on the specific details of the example.

A business model or any other model for modeling a process includes a large number of steps or elements. As previously indicated these are complicated to view, analyze, debug or whatever. The business model models the processes and then exports the process to a selected runtime workflow engine, such as the IBM Diamond (™) engine for deployment and automation of the processes. The observation model is used when a user wishes to monitor one or more of the process elements to capture the business measures. This observation model can be used for any process and acts as a starting point for adding or amending business measures. One of the core elements in the observation model, is an element that is called the “monitoring context” which is created for any element that is, or is to become, a business measure. Details of this will be described in greater detail below.

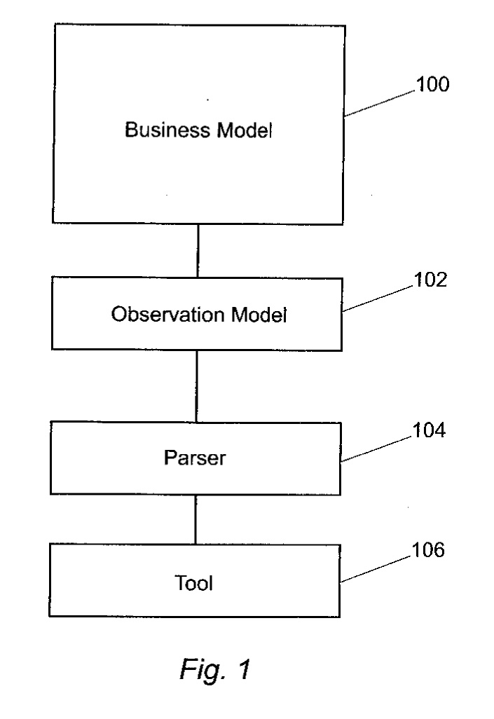

Referring to FIG. 1, a broad overview or the invention is shown. A business model 100 may be observed by an observation model 102, such as an Eclipse modeling frame work (EMF). A parser 104 is used to analyze the elements of the model to determine “parent” (in other words a business measure element) and “child” (in other words a sub element of the business measure). Business measures include (but are not limited to) the following: metrics, key performance indicators, counters and timers.

A tool (which may also be referred to as the template model in later details) 106 then sorts the elements into syntactic components to identify the “parent” (in other words a business measure element) and “child” relationships between each component and generate a tree representation of the model. This occurs despite the fact that there is no real parent/child relationships between each parent and child. The tree representation shows the “parent” components as one level of the tree diagram and the “child” components at one or many sub levels. In other words some of the “child” components will be “parent” components of other “child” components. By being able to convert the business model or observations model into such a format it is possible to more effectively visualize the model.

The determination by the parser of which “child” belongs to which “parent” is carried out based on the attributes and properties of both the “parent” and “child”. This is carried out either through the business model attributes and properties, or those of the observation model. The complexity of the business or observations models is hidden from the user by the use of the tool or template model. The user can view and easily take in the comments of the template model and the overall system includes a means (not shown) which acts as an interface and converter between the template model and the observation model. The result of the operation of the tool 106 and parser 104 is shown as the tree 200 in FIG. 2. The tree is a “snapshot” of the tool when opening the observation model. The tool 106 visualizes the observation model as a tree and then the model can be examined or inspected by expansion of each tree node 202, 204, 206, etc. By expanding the tree nodes it is possible to view the contents. Subsequent selection of any element in the tree will enable the user to view the properties, attributes etc. in the property view which will be described in greater detail below.

The names of the various “parents” and “child” elements will depend on particular circumstance but in this case have no particular or important meaning. The modeler generates the monitoring context 208 for each of the user tasks. The model (indicated as GNDA) shown is used for testing and integration purposes.

As can be seen from FIG. 2 the tool creates a logical grouping of nodes in the following mains areas:
observation models
monitoring contexts
descriptors
inbound events
outbound events
metrics
keys
counters
timers
situations
event types
maps
etc . . .

The use of such a logical grouping (in this form or others) allows improved viewing of the component element of the business model and thus any tasks, amendments etc. can be more easily carried out.

The different nodes of the model are best described with reference to FIG. 2. The actual model element node is the actual element in the model and are shown as 202, 204 and 206 in FIG. 2. The logical nodes act as logical grouping nodes for elements of the same kind. For example, 208 in FIG. 2 is the logical grouping node which groups all elements in the monitoring context. Observation models, monitoring contexts, descriptors, inbound events, outbound events, metrics, keys, counters, timers, situations, event types and maps are all logical nodes used for logical grouping and do not represent any real elements in the input model.

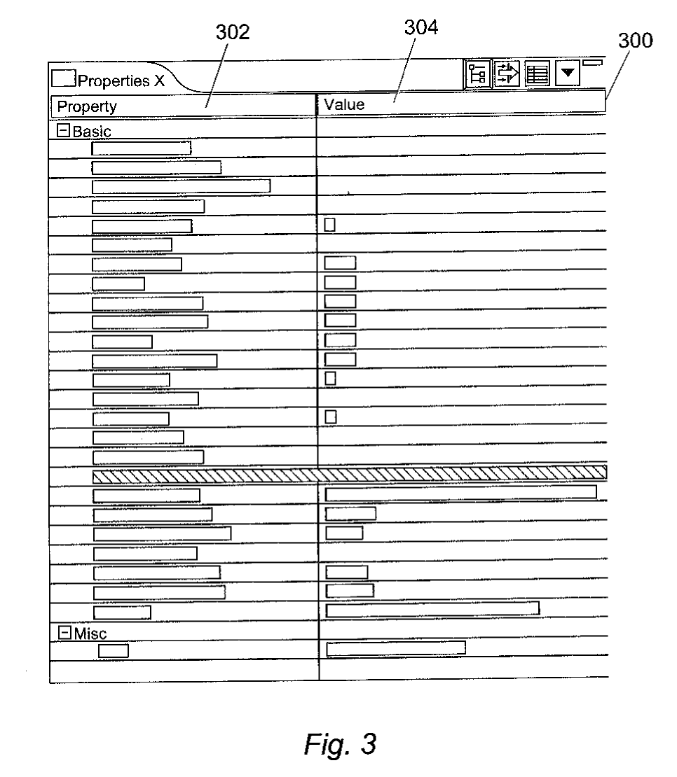

As previously indicated if an element of the tree is selected a property view is shown, this is illustrated in FIG. 3. The basic property view 300 is displayed and in this example illustrates a selection of properties relevant to the business model in question. The property field 302 and value field 304 for each property will similarly vary from model to model.

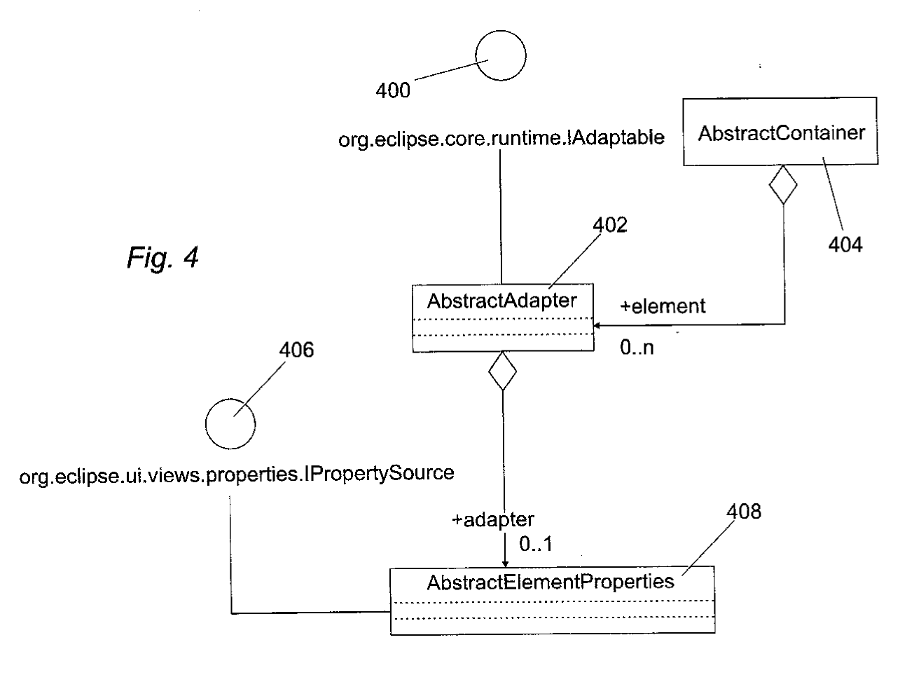

Referring now to FIG. 4 a process is illustrated for enabling a linkage between the logical grouping nodes and AbstractContainer and AbstractAdapter classes for the Eclipse (EMF) property view.

As previously indicated the tool is developed inside the eclipse framework (which may act as the core platform for both modelers or monitors, such as the WBI modeler and monitor from IBM). The eclipse framework has a standard view or “window” called “Property View” as previously indicated. This view can interact with any selection inside any other view to supply a properties list (if such a list exists) for the particular selection. The tool implements its own view inside the Eclipse Called “Observation Model Viewer”. However, rather than implement a second view (i.e. the Observation Model Property Viewer) to display the properties for any selected observation model element ready made rich standard Eclipse Property view may instead be used. The property view will not act with the selection unless the selection causes implementation of an eclipse interface called “IAdaptable” 400. An abstract class “AbstractAdapter” 402 is produced which includes all of the tree elements in the Observation Model viewer that represents an observation model element. These are derived from the “AbstractContainer” 404. Thus every element in the tree is wrapped inside a class of “AbstractAdapter” type.

When the property view finds that the current selection is implemented “IAdapter” interface it can then request that this selection provides its own properties. The selected element will then supply the eclipse property view with an object that represents the properties and that the property view can understand. The object in turn then implements the Eclipse interface “IPropertySource” 406. Thus for every “AbstractAdapter” object that represent an observation model element there should be an object that implements the interface “IPropertySource”. This object is called the “AbstractElementProperty” 408. This object “AbstractElementProperty” is auto-generated for each element in the observation model that is displayed in the tool. This auto generation is achieved by using a technique called “reflection”. By means of reflection any given object may be inspected and all its properties determined. Thus if the property view requests the property source object of the current selection in the tool, the tool uses the reflection method to build up this object and then return it to the property view.

Using the above described process will allow editing of the following property types:-
Boolean
String
Array of strings
Numeric properties
etc.

The autogenerated property will be of a specific format which is readable by the eclipse property view. Thus when a user selects an element from the tree that represents the observation model, the tool will automatically generate a property object which the eclipse property view (EMF) can understand.

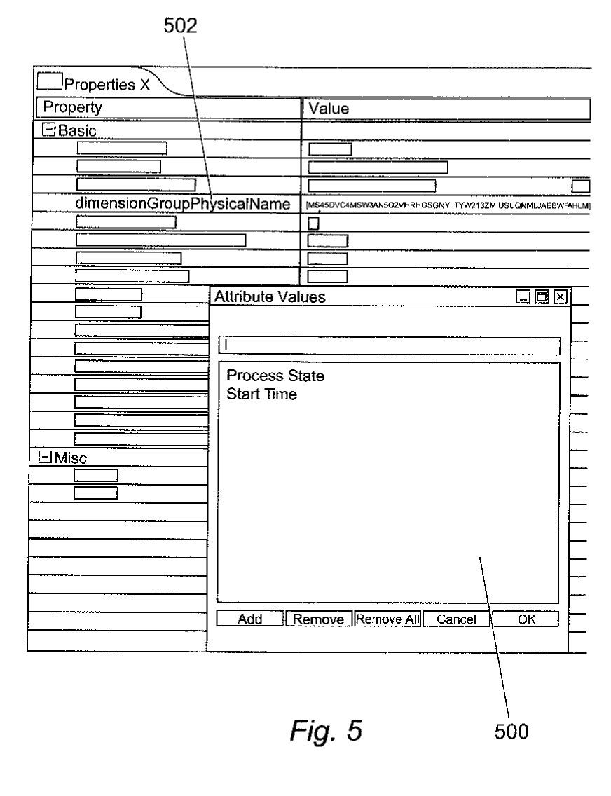

FIG. 5 shows the generation of a multi valued property display box 500. The tool 106 includes a mechanism for identifying that a multi valued property forms part of an element (“parent” or “child”) and when this element is selected opens the display box 500 instead of the table view that is shown in FIG. 3. The property view displays the properties of the selected element 502 of the Observation Model Viewer not shown in FIG. 5. In FIG. 5 the properties belong to a selected element of type “Descriptor”. Descriptors are a modeling element used to store extra information that the element can not carry by virtue of the format thereof. Descriptors are complex and thus the multi valued property box helps users to Create, edit, or read descriptor information that is associated with a specific element in a standard manner. Any Business model element can carry more than one descriptor element. In order to attach descriptors for any element a logical grouping node (called descriptors) will be require under the element node.

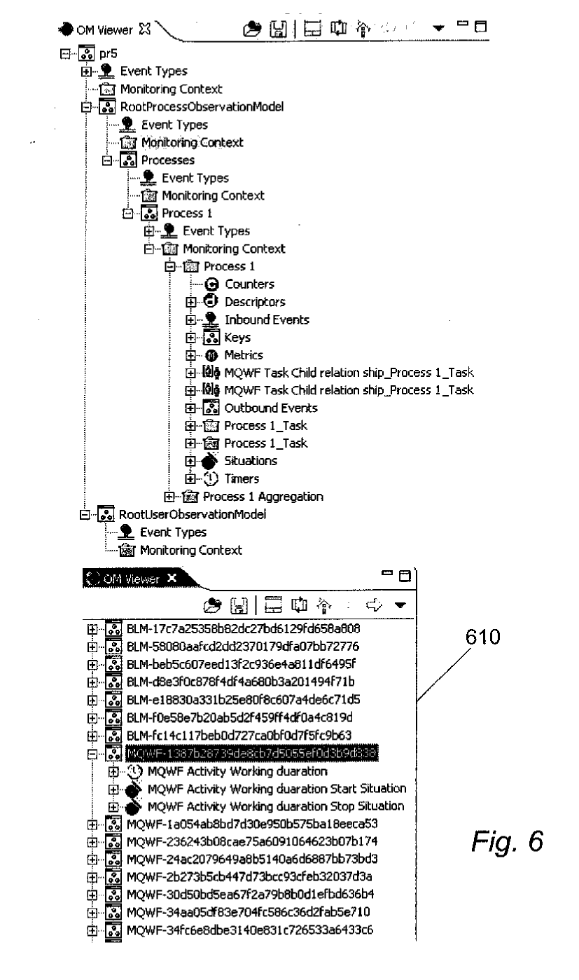

The tool 106 also includes a debugging facility which determines the template in which the elements are grouped. The template model is a high level model that exists “above” the observation model, but can be integrated into the observation model for viewing as is shown with reference to FIG. 6. This figure shows an example of displaying the current Business Model input 600 from the template model perspective. The top level tree nodes represent the template element ID. This view is constructed from the information stored in a descriptor called “Template Descriptor” which is attached to all the element in the model. This descriptor stores the information about the corresponding template ID for the described element.

The observation model operates in conjunction with the template model. The two are distinct models as previously described. The observation model is part of the business model for viewing the same. The template model is a hidden model which acts as a wrapper around the business and observation models and acts like an abstraction model.

The process of expanding the template model results in certain source information of the template being incorporated into the observation model. This source information is then stored in a descriptor with each element. The debugging facility of the tool can then use this descriptor information to rebuild the original template model and display a tree view 610 that groups the elements that come from the same template into on node, with the name of the node being the source template ID.

As previously described the template model is transient but is of great practical advantage to the user. If any errors are detected in the business or observation model the template model assists in the determination of a solution. Examples of errors include: defects in the transformation between the template and observation models; defects in the export layer; defects in the business measures editor and/or just bad modeling. It would previously have been impossible to determine and fix these errors, but the tool of the present invention overcomes this problem. In addition the template model allows for user checks to be carried out where previously machine checks were the only possible alternative. Obviously this could introduce further errors if the machine checks were badly programmed as well. The template model provides an observation viewing facility which has never existed and which has many advantages, as indicated herein.

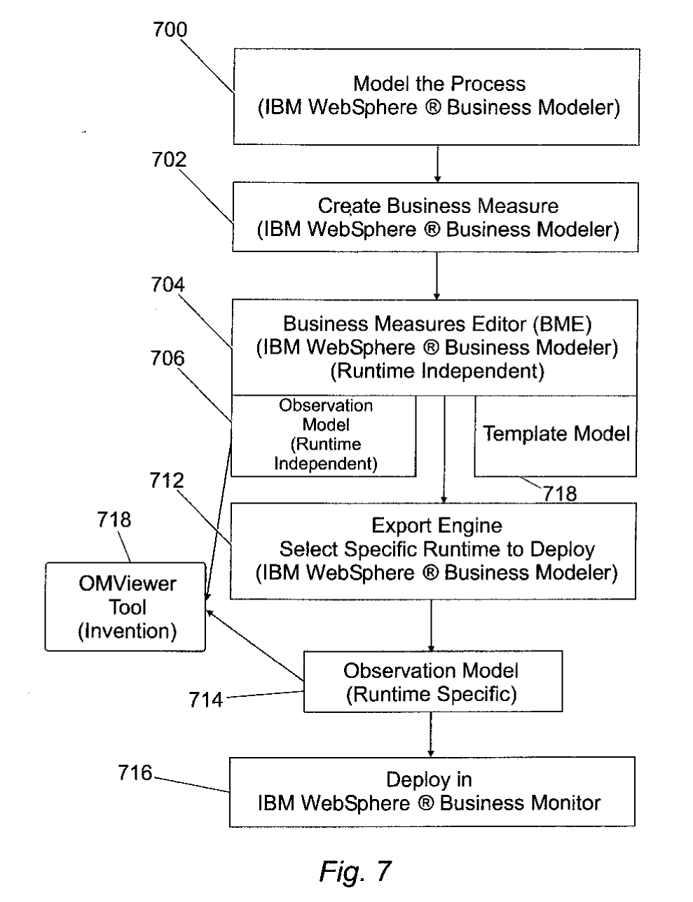

FIG. 7 sets out a high level view of the present invention. The business process is modeled 700. The business model is used to create one or more business measures 702. A business measures editor 704 is used to support the observation model 706 and the template model 708 in accordance with the present invention. Both the observation model and business measures editor are runtime independent. The observation model may be viewed using the Observation Model viewer tool 710 (which forms part of the tool 106) and is used to allow a user to have clear visibility of the business measure editor and make changes to the model as necessary or required. The output from the business measures editor is passed to an export engine which is used to select a specific runtime to deployment of any amendments or changes to the business model 712. A runtime specific observation model is again employed 714 to visualize the changes to the model and is viewed using the Observation Model viewer tool 710. The changes to the business model are then deployed in the business model 716.

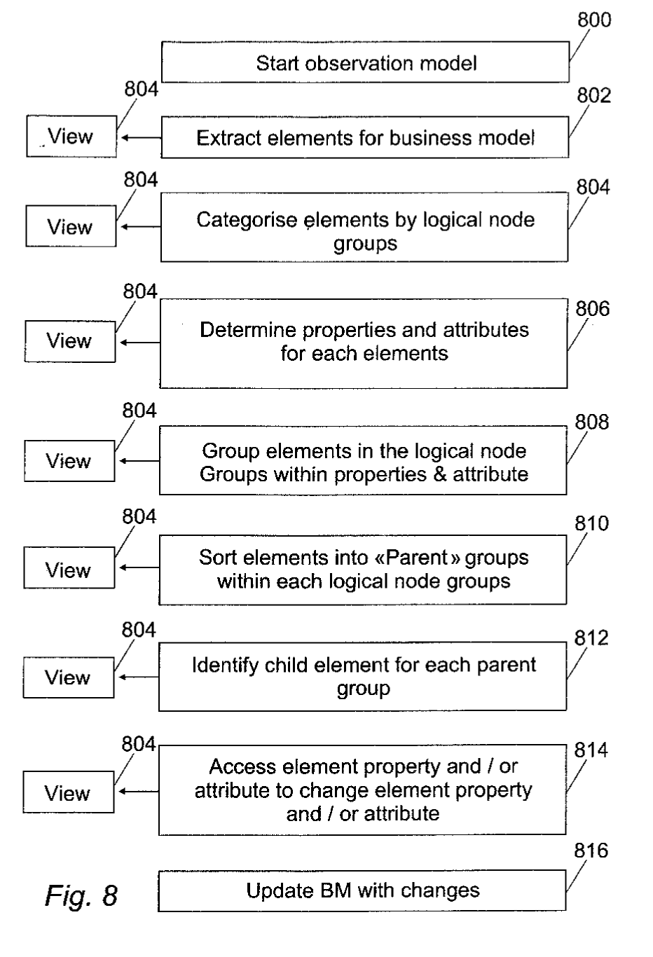

FIG. 8 shows the details of the steps of the method of FIG. 7 which relate to the observation model and associated observation model viewer. The observation model starts 800 and views the business model and any other associated elements, such as the template model etc . . . The business model elements are extracted from the business model 802 and may be viewed 804 using the observation model viewer. The view at this point is a long list of all business model elements.

The elements are reviewed and the required logical node groups are determined. The elements of the model are then categorized in one or other of the logical node groups 806. At each step of the process the model or evaluation, amendment or otherwise of the step can be viewed through the observation model viewer, 804 which is shown at each stage. The properties and attributes for each group are determined and this information is stored with the respective elements which are then placed in the relevant logical node group 808. The logical node group now includes the elements and their respective attributes, properties, name and any other relevant information. As with earlier steps of the process these results can be viewed through the observation model viewer.

The elements in each logical node group are then analyzed to determine the linkages between various elements, in order to identify “parent” elements in the hierarchy of the business model 810. For each “parent” element a determination is made to identify the “child” and “grandchild” element and attribute those to the relevant “parent” element 812. This provides a user friendly view via the observation model viewer of the elements in the business model and some of their high level relationships. The user may this visualize the business model. In fact, the business model can actually acts as an input model to observe the running process.

Now if any changes, amendments, debugging etc. are required a user can make these changes in a format which is easy to use and clear to operate 814. The changes may be made to the elements, names, properties, attributes or whatever. These changes are then converted back into a format which is acceptable to the business model or other associated tool which can pass the changes etc. into the business model for updating the same 816.

It will be appreciated that the order of the steps in this part of the method can be different from that indicated above. Although it will be appreciated that certain steps must logically become before certain other steps. In addition, some or more of the elements of one step in the method above may be in other steps if it is easier or more logical for the user to carry out the method in a different order.

1. A method of carrying out a certain action on a model, such as a business model, wherein the model includes a plurality of elements, or each of which represent a part of the model, the method comprising:
extracting each element of the model using a element extraction process;
determining a logical grouping for each extracted element;
determining one or more parameters relating to each extracted element;
determining a hierarchy of the extracted elements to produce a hierarchical tree diagram of the extracted elements of the model based on the logical grouping;
including the or each parameter with each extracted element in the hierarchical tree diagram;
using the hierarchical tree diagram to access the one or more parameters of each element to allow the certain action to be carried out.

2. The method of claim 1, wherein the step of producing the hierarchical tree diagram includes determining parent and child elements of the model in the hierarchy and grouping the child elements with the respective parent elements.

3. The method of claim 2, wherein the step of determining the parent and child elements of the model comprises parsing the extracted elements.

4. The method of any preceding claims, wherein the step of determining the logical groupings comprises selecting the groupings from a group including observation models; monitoring contexts; descriptors; inbound events; outbound events; metrics; keys; counters; timers; situations; event types; maps.

5. The method of any preceding claim, further comprising selecting a extracted element from the hierarchical tree diagram and thereby viewing the or each parameter thereof and carrying out the action by changing one or more of said parameters.

6. The method of any preceding claim, further comprising determining the existence of each parameters from a different source than the hierarchical tree diagram if it already exists elsewhere.

7. The method of any preceding claim, wherein the step of carrying out the actions comprises carrying out one or more functions.

8. The method of claim 7, further comprising selecting the functions from the group containing: viewing, updating, amending, debugging, reviewing, redesigning, fault finding, repairing, remodeling.

9. A system comprising means adapted for carrying out the steps of the method according to any one of the preceding claims.

10. A computer program comprising instructions for carrying out the steps of the method according to any one of claims 1, when said computer program is executed on a computer system.
